(19) United States
(12) Patent Application Publication
(10) Pub. No.: US 2026/0234010 A1
(43) Pub. Date: Aug. 13, 2026

(54) SYNTHESIS OF CHA ZEOLITIC MATERIALS, CHA ZEOLITIC MATERIALS OBTAINABLE THEREFROM AND SCR CATALYSTS COMPRISING THE SAME

(71) Applicant: BASF MOBILE EMISSIONS CATALYSTS LLC, Iselin, NJ (US)

(72) Inventors: Xiao Duo QI, Shanghai (CN); Li Hua SHI, Liaoning (CN); Vivek VATTIPALLI, Iselin, NJ (US); Yu DAI, Shanghai (CN); Ming Ming WEI, Shanghai (CN); Hai Tao LIU, Liaoning (CN); Jin LI, Liaoning (CN)

(21) Appl. No.: 19/159,222

(22) PCT Filed: Feb. 27, 2024
(86) PCT No.: PCT/CN2024/078776

§ 371 Date: Aug. 22, 2025

Related U.S. Application Data
(63) Continuation of application No. PCT/CN2023/078751, filed on Feb. 28, 2023.

(30) Foreign Application Priority Data
Feb. 28, 2023 (WO) PCT/CN2023/078751

(51) Int. Cl. C01B 39/48; B01D 53/94

(52) U.S. Cl. CPC C01B 39/48; B01D 53/9418; B01D 2255/50; B01D 2257/404; B01D 2258/01; C01P 2002/72; C01P 2004/03

(57) ABSTRACT

A process for preparing a zeolite having a CHA-type framework structure comprising X2O3 and YO2, wherein X is a trivalent element and Y is a tetravalent element, which includes (1) preparing a synthesis mixture comprising (A) a source for X2O3, (B) a source for YO2, and (C) a source for an organic structure directing agent (OSDA) comprising a diquaternary ammonium cation of formula (I) or a combination of diquaternary ammonium cations of formula (R1R2R3)N+(CH2)nN+(R4R5R6) (I) as defined in claims and (2) subjecting the synthesis mixture to crystallization conditions to form a zeolite having a CHA-type framework structure. The present invention also relates to the zeolite having a CHA-type framework structure obtained from the process and use of the zeolite in catalysts for selective catalytic reduction of nitrogen oxides.

### FIELD OF THE INVENTION

The present invention relates to a process for synthesis of zeolitic materials having a CHA-type framework structure, the zeolitic materials obtainable therefrom, and SCR catalysts comprising the same.

### BACKGROUND

Catalytic articles are essential for modern internal combustion engines to treat exhausts therefrom before emission to air. The exhausts from internal combustion engines typically comprise particulate matter (PM), nitrogen oxides (NOx) such as NO and/or NO₂, unburned hydrocarbons (HC), and carbon monoxide (CO). Control of NOx emissions is always one of the most important topics in automotive field, due to the environmentally negative impact of NOx on ecosystem, animal and plant life.

One of effective techniques for removal of NOx from internal combustion engine exhausts is selective catalytic reduction (SCR) of NOx with ammonia or a secondary ammonia source. Recently, small pore zeolites were proposed for the selective catalytic reduction of NOx, among which CHA-type zeolite has been studied extensively and found as one of the most promising SCR catalysts, particularly when the zeolite is exchanged with a metal promoter such as Cu or Fe.

Chabazite is a type of naturally occurring zeolite, and also has synthetic CHA forms. A well-known synthetic CHA-type zeolite is the crystalline CHA material designated as SSZ-13, as reported in U.S. Pat. No. 4,544,538. SSZ-13 was prepared using a structure directing agent comprising N-alkyl-3-quinuclidinol cation, N,N,N-trialkyl-1-adamantammonium cation, N,N,N-trialkyl-2-exoaminonorbornane cation or mixtures thereof under crystallization conditions. Synthesis of CHA-type zeolite using other structure directing agents has also been developed, as reported for example in following non-patent and patent documents.

Itakura Masaya et. al. in Chemistry Letters, 2008, Vol. 37, No. 9, pages 908 to 909, describes a process for synthesis of CHA Zeolite with benzyltrimethylammonium hydroxide as the structure directing agent.

US 2010/254895 A1 discloses a process for preparing CHA-type zeolite using cationic 1,4-diazabicyclo[2.2.2]octane-based structure directing agent in conjunction with at least one cationic cyclic nitrogen-containing structure directing agent.

WO 2020/039074A1 discloses a process for preparing CHA-type zeolite using a structure directing agent comprising a cation having the formula [NR¹R²R³R⁴], in which R¹, R², R³ and R₄ are independently C₁-C₄-alkyl groups optionally substituted by one or more hydroxy groups.

Biaohua Chen et al. in Environmental Science & Technology, 2014, 48, pages 13909 to 13916, describes a process for synthesis of SSZ-13 with choline chloride as the structure directing agent.

WO 2013/035054 A1 discloses a process for the preparation of a zeolitic material having a CHA-type framework structure, wherein the process employs N,N-dimethylammonium organotemplates including N,N-dimethylpiperidinium.

There remains a need of more processes for preparing zeolite materials having a CHA-type framework structure, particularly processes which could provide CHA-type zeolite materials having improved catalytic performance for selective catalytic reduction of NOx.

### SUMMARY OF THE INVENTION

It is an object of the present invention to provide a novel process for preparing a zeolite material having a CHA-type framework structure. Another object of the present invention is to provide an SCR catalyst based on a zeolite having a CHA-type framework structure, which has improved catalytic performance for selective catalytic reduction of NOx.

The objects were achieved by using a linear diquat organic structure directing agent (OSDA) in the zeolite synthesis. It has been surprisingly found that the zeolite having a CHA-type framework structure as prepared with the linear diquat organic structure directing agent has desirable activity, particularly combined with excellent stability against aging at a high temperature, for example 800° C. or higher.

Accordingly, in the first aspect, the present invention relates to a process for preparing a zeolite material having a CHA-type framework structure comprising X₂O₃ and YO₂, wherein X is a trivalent element and Y is a tetravalent element, which includes
(1) preparing a synthesis mixture comprising
   (A) a source for X₂O₃,
   (B) a source for YO₂, and
   (C) a source for organic structure directing agent (OSDA) comprising a diquaternary ammonium cation of formula (I) or a combination of diquaternary ammonium cations of formula (I),

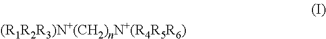

in which
   R₁, R₂, R₃, R₄, R₅ and R₆, independently from each other, are selected from C₁-C₁₀ alkyl, and
   n is an integer in the range of from 3 to 10,
or
in which
   one of R₁, R₂ and R₃ is selected from C₁-C₁₀ alkyl and the other two are linked together to form a C₄-C₆ alkylene,
   one of R₄, R₅ and R₆ is selected from C₁-C₁₀ alkyl and the other two are linked together to form a C₄-C₆ alkylene, and
   n is an integer in the range of from 3 to 10; and
(2) subjecting the synthesis mixture to crystallization conditions to form a CHA-type framework structure.

In the second aspect, the present invention relates to a zeolite having a CHA-type framework structure obtained and/or obtainable by the process as described herein.

In the third aspect, the present invention relates to a metal-promoted zeolite having a CHA-type framework structure, which comprises the zeolite obtained and/or obtainable by the process as described herein and a promoter metal.

In the fourth aspect, the present invention relates to use of the zeolite having a CHA-type framework structure according to the second aspect or use of the metal-promoted zeolite according to the third aspect in catalysts for selective catalytic reduction (SCR) of NOx.

In the fifth aspect, the present invention relates to a catalytic article in form of an extrudate comprising an SCR catalyst composition or in form of a monolith comprising a washcoat containing an SCR catalyst composition on a substrate, wherein the SCR catalyst composition comprises a metal-promoted zeolite having a CHA-type framework structure as described herein.

In the sixth aspect, the present invention relates to an exhaust gas treatment system comprising an internal combustion engine and an exhaust gas conduit in fluid communication with the internal combustion engine, wherein the catalytic article as described herein is present in the exhaust gas conduit.

### BRIEF DESCRIPTION OF THE DRAWINGS

FIGS. 1A, 1B and 1C show SEM images of the zeolites from Example 2, 3 and 4 (Zeolites A, B and C) respectively.

FIG. 2 show XRD patterns of the zeolites from Example 2, 3 and 4 (Zeolites A, B and C) respectively.

### DETAILED DESCRIPTION OF THE INVENTION

The present invention will be described in detail hereinafter. It is to be understood that the present invention may be embodied in many different ways and shall not be construed as limited to the embodiments set forth herein.

Herein, the singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

The terms “zeolite having a CHA-type framework structure”, “CHA-type zeolite”, “CHA zeolite” and the like as used herein are intended to refer to a molecular sieve material which shows an XRD pattern of a CHA-type framework structure, and will be used interchangeably with each other hereinbelow. Those terms are also intended to include any forms of the zeolite, for example as-synthesized form, calcined form, NH₄-exchanged form, H-form and metal-substituted form.

The term “as-synthesized” as used herein is intended to refer to a zeolite in its form after crystallization and drying, prior to removal of the organic structure directing agent.

The term “calcined form” as used herein is intended to refer to a zeolite in its form upon calcination.

In the first aspect, the present invention provides a process for preparing a zeolite having a CHA-type framework structure comprising X₂O₃ and YO₂, wherein X is a trivalent element and Y is a tetravalent element, which includes
(1) preparing a synthesis mixture comprising
   (A) a source for X₂O₃,
   (B) a source for YO₂, and
   (C) a source for an organic structure directing agent (OSDA) comprising a diquaternary ammonium cation of formula (I) or a combination of diquaternary ammonium cations of formula (I),

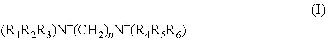

in which
   R₁, R₂, R₃, R₄, R₅ and R₆, independently from each other, are selected from C₁-C₁₀ alkyl, and
   n is an integer in the range of from 3 to 10,
or
in which
   one of R₁, R₂ and R₃ is selected from C₁-C₁₀ alkyl and the other two are linked together to form a C₄-C₆ alkylene,
   one of R₄, R₅ and R₆ is selected from C₁-C₁₀ alkyl and the other two are linked together to form a C₄-C₆ alkylene, and
   n is an integer in the range of from 3 to 10; and
(2) subjecting the synthesis mixture to crystallization conditions to form a zeolite having a CHA-type framework structure.

The synthesis mixture provided in step (1) comprises a source for X₂O₃ where X is a trivalent framework element and a source for YO₂ where Y is a tetravalent framework element. X may be any conventional trivalent framework element. Preferably, X is selected from the group consisting of Al, B, In, Ga and any combinations thereof, with Al being more preferable. Also, Y may be any conventional tetravalent framework element. Preferably, Y is selected from the group consisting of Si, Sn, Ti, Zr, Ge and any combinations thereof, with Si being more preferable. Particularly, X is Al and Y is Si.

Suitable source for X₂O₃ may be any known materials useful for providing trivalent framework element during zeolite synthesis. In some embodiments wherein X is Al, suitable examples of the source for Al₂O₃ may include, but are not limited to alumina, aluminum hydroxide, aluminates, aluminum alkoxides, aluminum salts, FAU zeolites, LTA zeolites, LTL zeolites, BEA zeolites, MFI zeolites and any combinations thereof, more preferably alumina, aluminum alkoxide, aluminum salts, FAU zeolites and any combinations thereof. Particularly, the source for Al₂O₃ may be selected from alumina, AlO(OH), Al(OH)₃, aluminum tri(C₁-C₅)alkoxide, aluminum halides, aluminum sulfate, aluminum phosphate, aluminum fluorosilicate, FAU zeolites and any combinations thereof. For example, the FAU zeolite may be selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, US-Y, ECR-30, LZ-210, Li-LSX, SAPO-37, ZSM-20, ZSM-3, Zeolite X and Zeolite Y, more preferably from the group consisting of faujasite, zeolite X, zeolite Y, US-Y and LZ-210. Zeolite Y may be particularly mentioned as the source for X₂O₃.

Suitable source for YO₂ may be any known materials useful for providing tetravalent framework element during zeolite synthesis. In some embodiments wherein Y is Si, suitable sources for YO₂ may include, but are not limited to fumed silica, precipitated silica, silica hydrosols, silica gels, colloidal silica, silicic acid, silicon alkoxides, alkali metal silicates, sodium metasilicate hydrate, sesquisilicate, disilicate, silicic acid esters, FAU zeolites, LTA zeolites, LTL zeolites, BEA zeolites, MFI zeolites and any combinations thereof. Particularly, the source for YO₂ may be selected from fumed silica, sodium silicate, potassium silicate, FAU zeolites and any combinations thereof, more preferably fumed silica, FAU zeolites and any combinations thereof. For example, the FAU zeolite may be selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, US-Y, ECR-30, LZ-210, Li-LSX, SAPO-37, ZSM-20, ZSM-3, Zeolite X and Zeolite Y, more preferably from the group consisting of faujasite, zeolite X, zeolite Y, US-Y, and LZ-210. Particularly, one or more materials selected from the group consisting of fumed silica, precipitated silica, silica hydrosols, silica gels, colloidal silica and zeolite Y may be mentioned as the source for YO₂.

It will be understood that the sources for X₂O₃ and YO₂ may be provided separately (i.e., separate sources) and/or conjointly (i.e., combined source). In the latter case, the sources may be provided by for example a zeolite containing framework elements X and Y. It can be contemplated that the synthesis mixture provided in step (1) may comprise a combined source for X₂O₃ and YO₂ and one or more additional separate sources for X₂O₃ and/or YO₂.

In some particular embodiments, the synthesis mixture provided in step (1) comprises a source for Al₂O₃ and a source for SiO₂, in form of separate sources or a combined source. Accordingly, an aluminosilicate zeolite having a CHA-type framework structure will be obtained from the process according to the present invention.

The term “aluminosilicate” as used within the context of zeolite is intended to mean the framework constructed primarily of alumina and silica, which may or may not comprise a framework element other than oxygen, aluminum, and silicon.

In certain illustrative embodiments, the synthesis mixture provided in step (1) comprises an FAU zeolite as the combined source for Al₂O₃ and SiO₂ and an additional source for SiO₂. Particularly the FAU zeolite is zeolite Y, which may be in Na⁺-form, H-form or NH₄⁺-exchanged form. Zeolite Y having a molar ratio of SiO₂ to Al₂O₃ of no more than 40 or no more than 30 is more preferable.

The additional source for SiO₂ is selected from the group consisting of fumed silica, precipitated silica, silica hydrosols, silica gels and colloidal silica, including mixtures of two or more thereof.

The synthesis mixture provided in step (1) has a YO₂:X₂O₃ molar ratio in the range of from 5 to 100, for example 10 to 60, or 15 to 30.

Suitable sources for organic structure directing agent (OSDA) may be compounds containing a diquaternary ammonium cation of formula (I) as described herein, particularly compounds containing a diquaternary ammonium cation of formula (I) in which R₁, R₂, R₃, R₄, R₅ and R₆, independently from each other, are selected from C₁-C₆ alkyl, and n is an integer in the range of from 3 to 10.

Preferably, the source for organic structure directing agent is selected from the compounds containing a diquaternary ammonium cation of formula (I)

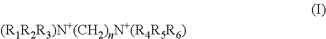

in which
R₁, R₂, R₃, R₄, R₅ and R₆ are the same and selected from C₁-C₆ alkyl, and
n is 4 to 7, or
   a combination thereof.

More preferably, the source for organic structure directing agent is selected from the compounds containing a diquaternary ammonium cation of formula (I), in which each of R₁, R₂, R₃, R₄, R₅ and R₆ is methyl, ethyl or propyl, preferably ethyl, and n is 5, 6 or 7, or a combination thereof.

Most preferably, the source for organic structure directing agent is selected from the compounds containing a diquaternary ammonium cation of following formula (Ia)

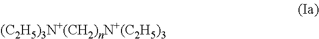

in which
n is 5, 6 or 7, or
a combination thereof.

In some particular embodiments, the organic structure directing agent comprises N,N,N,N′,N′,N′-hexaethyl-1,5-pentanediammonium (Et6-diquat-5), i.e., a diquaternary ammonium cation of formula (I) in which each of R₁, R₂, R₃, R₄, R₅ and R₆ is ethyl and n is 5, or of formula (Ia) in which n is 5.

Suitable compounds comprising a diquaternary ammonium cation of formula (I) or (Ia) may be in form of salts. There is no particular restriction to counterions i.e., anions of the salts, which may be halides such as fluoride, chloride and bromide, hydroxide, sulfate, nitrate, carboxylates such as acetate, and any combinations thereof. Particularly, the anions may be selected from the group consisting of chloride, bromide, hydroxide, sulfate or any combinations thereof. Preferably, the compounds comprising a diquaternary ammonium cation are hydroxides, chlorides or bromides, and particularly hydroxides of the diquaternary ammonium cations of formula (I) or (la) as described hereinabove.

According to the present invention, the organic structure directing agent (OSDA) may or may not comprise a cation other than the diquaternary ammonium cation of formula (I) or (la) as described herein. In some particular embodiments, the organic structure directing agent (OSDA) and thus the synthesis mixture provided in step (1) comprises no cation of OSDA other than the diquaternary ammonium cation of formula (I) or (Ia) as described herein.

Preferably, the synthesis mixture provided in step (1) has a molar ratio of the diquaternary ammonium cation (Q) to the source(s) for YO₂, calculated as YO₂ (Q:YO₂), in the range of from 0.01 to 1.0, for example 0.05 to 0.5, or 0.08 to 0.2.

The synthesis mixture provided in step (1) may further comprise a source for alkali metal and/or alkaline earth metal cations (AM), preferably alkali metal cations. The alkali metal is preferably selected from the group consisting of Li, Na, K, Cs and any combinations thereof, more preferably Na and/or K, and most preferably Na. The alkaline earth metal is preferably selected from the group consisting of Mg, Ca, Sr and Ba and any combinations thereof. Suitable sources for alkali metal and/or alkaline earth metal cations (AM) are typically halide such as fluoride, chloride and bromide, hydroxide, sulfate, nitrate and carboxylate such as acetate of the alkali metal and/or alkaline earth metal, or any combinations thereof. Preferably, the sources for the alkali metal and/or alkaline earth metal cations (AM) include chloride, bromide, hydroxide or sulfate of the alkali metal and/or alkaline earth metal, or any combinations thereof. More preferably, hydroxide of the alkali metal is used in the synthesis mixture.

The alkali metal and/or alkaline earth metal cations (AM) may be present in the synthesis mixture in a molar ratio relative to the source(s) for YO₂, calculate as AM to YO₂, in the range of from 0.01 to 1.0, for example 0.03 to 0.5, or 0.05 to 0.3.

The synthesis mixture provided in step (1) may also comprise a source for anion OH⁻. Useful sources for OH⁻ may be for example metal hydroxides such as alkali metal hydroxides, quaternary ammonium hydroxides. Preferably, the anion OH⁻ may be originated from one or more of the sources for alkali metal and/or alkaline earth metal cations (AM) and the source for organic structure directing agent.

The OH⁻ anion may be present in the synthesis mixture in a molar ratio relative to the source(s) for YO₂, calculated as OH⁻ to YO₂, in the range of from 0.1 to 2.0, for example 0.1 to 1.0, or 0.2 to 0.5.

The synthesis mixture provided in step (1) may further comprise at least one solvent, preferably water, more preferably deionized water. The solvent may be comprised in one or more of starting materials of the synthesis mixture, such as the sources for X₂O₃, YO₂ and the organic structure directing agent and thus be carried into the synthesis mixture, and/or may be incorporated into the synthesis mixture separately.

In some embodiments, the synthesis mixture has a molar ratio of water to the source(s) for YO₂, calculated as H₂O to YO₂, in the range of from 3 to 100, for example 10 to 80, or 10 to 40.

In some exemplary embodiments, the synthesis mixture provided in step (1) have a molar composition as shown in the Table 1 below.

TABLE 1

| Ingredient Ratios¹⁾ | Broad | narrow | narrower |
|---|---|---|---|
| YO₂/X₂O₃ | 5 to 100 | 15 to 60 | 15 to 30 |
| Q/YO₂ | 0.01 to 1.0 | 0.05 to 0.5 | 0.08 to 0.2 |
| AM/YO₂ | 0.01 to 1.0 | 0.03 to 0.5 | 0.05 to 0.3 |
| OH⁻/YO₂ | 0.1 to 2.0 | 0.1 to 1.0 | 0.2 to 0.5 |
| H₂O/YO₂ | 3 to 100 | 10 to 80 | 10 to 40 |

¹⁾the amounts of the sources for X₂O₃ and YO₂ are calculated as respective oxides

In some embodiments, the synthesis mixture provided in step (1) may further comprise an amount of seed crystals of CHA zeolite. The seed crystals of CHA zeolite may be obtained from the process as described herein without using seed crystals, or from any other known processes.

The synthesis mixture may be subjected to crystallization conditions to form a zeolite having a CHA-type framework structure in step (2) with no particular restriction. The crystallization may be carried out at an elevated temperature in the range of from 80 to 250° C., more preferably from 100 to 200° C., for a period sufficient for crystallization, for example 0.5 to 12 days, or 1 to 6 days. Typically, the crystallization is carried out under autogenous pressure, for example in a pressure tight vessel such as an autoclave. Further, the crystallization may be carried out with or without agitation.

The CHA zeolite as formed by crystallization may be subjected to a work-up procedure including isolating for example by filtration, optionally washing, and drying to obtain the as-synthesized CHA zeolite. Accordingly, step (2) in the process according to the present invention optionally further comprises the work-up procedure.

The organic structure directing agent remaining, if any, in the filtrate liquid from the filtration and optionally the washed liquid from the washing may be recycled, and used for further synthesis of the CHA zeolite.

The as-synthesized CHA zeolite typically comprises the diquaternary ammonium cations as described hereinabove within its structure pores and/or channels.

In some embodiments, the as-synthesized CHA zeolite from step (2) may be subjected to a calcination procedure. Accordingly, the process according to the present invention further comprises step (3) of calcination of the as-synthesized CHA zeolite.

In some embodiments, the as-synthesized or the as-calcined CHA zeolite may be subjected to an ion-exchange procedure such that one or more of ionic non-framework elements contained in the zeolite are exchanged to H⁺ and/or NH₄⁺. Accordingly, the process according to the present invention further comprises (4) exchanging one or more of ionic non-framework elements contained in the zeolite obtained in step (2) or (3) to H⁺ and/or NH₄⁺, preferably NH₄⁺.

Generally, the zeolite having been exchanged to H⁺ and/or NH₄⁺ in step (4) may be subjected to a work-up procedure including isolating for example by filtration, optionally washing, and drying, and/or subjected to a calcination procedure. Accordingly, step (4) in the process according to the present invention optionally further comprises the work-up procedure and/or calcination procedure.

The calcination in step (3) and/or step (4) may be carried out at a temperature in the range of from 300 to 900° C., for example 350 to 700° C., or 400 to 650° C. Particularly, the calcination may be performed in a gas atmosphere having a temperature in the above-described ranges, which may be air, oxygen, nitrogen, or a mixture of two or more thereof. Preferably, the calcination is performed for a period in the range of from 0.5 to 10 hours, for example 3 to 7 hours, or 4 to 6 hours.

Zeolites having a CHA-type framework structure could be successfully obtained from the process as described in the first aspect, as determined by X-ray powder diffraction (XRD) analysis.

Accordingly, in the second aspect, the present invention provides a zeolite having a CHA-type framework structure obtainable and/or obtained from the process as described in the first aspect.

The zeolite having a CHA-type framework structure has a YO₂:X₂O₃ molar ratio (SAR) of YO₂ (e.g. silica) to X₂O₃ (e.g. alumina) of 2 or more, wherein the molar ratio is preferably comprised in the range of from 4 to 200, more preferably of from 6 to 100, more preferably of from 8 to 50, more preferably of from 10 to 35, more preferably of from 15 to 30, most preferably 18 to 25. According to the present invention, the YO₂:X₂O₃ molar ratio preferably refers to the zeolite having a CHA-type framework structure in its calcined form, more preferably in its calcined H-form.

The zeolite having a CHA-type framework structure according to the present invention typically has an average crystal size of at least 200 nm, for example in the range of from 0.2 to 6 μm. The average crystal size may be determined via scanning electron microscopy (SEM). Particularly, the average crystal size was determined via SEM by measuring the crystal sizes for at least 30 different crystals selected at random from multiple images covering different areas of the sample.

It has been surprisingly found that the zeolite having a CHA-type framework structure according to the present invention has a crystal morphology with a mosaic-pattern texture of crystal surfaces, as observed via SEM. Herein, the mosaic-pattern is used to describe the surface morphology of the crystals of the zeolite having a CHA-type framework structure, which is intended to refer to a surface pattern made of small irregular-shape pieces with irregular-shape gaps therebetween.

The zeolite having a CHA-type framework structure according to the present invention is preferably at least 90% phase pure, i.e., at least 90% of the zeolite framework is of CHA type, as determined by X-ray powder diffraction (XRD) analysis. More preferably, the zeolite having a CHA-type framework structure is at least 95% phase pure, or even more preferably at least 98% or at least about 99%. Correspondingly, the zeolite having a CHA-type framework structure may contain some other framework as intergrowth in minor amounts, for example less than 10%, preferably less than 5%, even more preferably less than 2% or less than 1%.

It has been surprisingly found that the zeolite having a CHA-type framework structure as obtained from the process as described in the first aspect exhibits significantly higher stability against aging at a temperature of 800° C. or higher in the application of selective catalytic reduction (SCR) of NOx, compared with the catalysts comprising a zeolite having the same type of framework but prepared otherwise.

Accordingly, in the third aspect, the present invention further provides a metal-promoted zeolite having a CHA-type framework structure, which comprises the zeolite obtained and/or obtainable by the process according to the present invention and a promoter metal.

The term “promoter metal” as used herein refers to a non-framework metal capable of improving the catalytic activity of a zeolite. The “non-framework metal” is intended to mean that the metal does not participate in constituting the zeolite framework structure. The promoter metal may reside within the zeolite and/or on at least a portion of the zeolite surface.

Herein, the promoter metal is particularly present within the zeolite having a CHA-type framework structure and/or on at least a portion of the surface thereof.

The zeolite having a CHA-type framework structure is the zeolite as obtained and/or obtainable by the process described in the first aspect and/or the zeolite as described in the second aspect. Any general and particular descriptions with respect to the process in the first aspect or the zeolite having a CHA-type framework structure in the second aspect are incorporated here by reference.

The promoter metal may be any metals known useful for improving catalytic performance of zeolites in the application of selective catalytic reduction (SCR) of NOx. Generally, the promoter metal may be selected from transition metals, for example precious metals such as Au, Ag and platinum group metals, base metals such as Cr, Zr, Nb, Mo, Fe, Mn, W, V, Ti, Co, Ni, Cu and Zn, alkali earth metals such as Ca and Mg, and Sb, Sn and Bi, and any combinations thereof.

In some embodiments, the metal-promoted zeolite having a CHA-type framework structure comprises Cu and/or Fe as the promoter metal. In some particular embodiments, the metal-promoted zeolite comprises Cu as the promoter metal.

The promoter metal may be present in the metal-promoted zeolite having a CHA-type framework structure at an amount of 0.1 to 10% by weight, preferably 0.5 to 10% by weight, on an oxide basis, based on the total weight of the promoter metal and the zeolite having a CHA-type framework structure. In some particular embodiments wherein copper, iron or the combination thereof is used as the promoter metal, the promoter metal is preferably present in the metal-promoted zeolite having a CHA-type framework structure at an amount of 1 to 8% by weight, more preferably 2 to 6% by weight, on an oxide basis, based on the total weight of the promoter metal and the zeolite having a CHA-type framework structure.

Alternatively, the promoter metal may be present in the metal-promoted zeolite having a CHA-type framework structure at an amount in the range of from 0.01 to 2 moles, for example 0.03 to 1.8 moles, 0.05 to 1.5 moles, 0.08 to 1.2 moles, 0.1 to 1.0 moles, 0.13 to 0.8 moles, per mole of the trivalent framework element (e.g. Al) of the zeolite having a CHA-type framework structure. In some particular embodiments wherein copper, iron or the combination thereof is used as the promoter metal, the amount of the promoter metal is 0.1 to 1.0 moles, preferably 0.15 to 0.8 moles, more preferably 0.2 to 0.6 moles, most preferably 0.3 to 0.5 moles, per mole of the trivalent framework element (e.g., Al) of the zeolite having a CHA-type framework structure.

In some preferable embodiments, the metal-promoted zeolite having a CHA-type framework structure according to the present invention comprises
an aluminosilicate zeolite having a CHA-type framework structure, which has a molar ratio of silica to alumina (SAR) in the range of from 10 to 35, and
a promoter metal selected from Cu, Fe or a combination thereof, particularly Cu, wherein the promoter metal is present at an amount of 0.2 to 0.6 moles, preferably 0.3 to 0.5 moles per mole of framework aluminum of the zeolite.

In some more preferable embodiments, the metal-promoted zeolite having a CHA-type framework structure according to the present invention comprises
an aluminosilicate zeolite having a CHA-type framework structure, which has a molar ratio of silica to alumina (SAR) of 15 to 30, more preferably 18 to 25, and
a promoter metal which is Cu,
   wherein Cu is present at an amount of 0.2 to 0.6 moles per mole of framework aluminum of the zeolite.

In an exemplary embodiment, the metal-promoted zeolite having a CHA-type framework structure, according to the present invention comprises
an aluminosilicate zeolite having a CHA-type framework structure, which has a molar ratio of silica to alumina (SAR) of 18 to 25, and
a promoter metal which is Cu,
   wherein Cu is present at an amount of 0.3 to 0.5 moles per mole of framework aluminum of the zeolite.

Preferably, the metal-promoted zeolite having a CHA-type framework structure according to the present invention upon steam aging with 10% H₂O at 820° C. could exhibit NOx conversions of at least 50% at 200° C. and at least 60% at 575° C. in a test gas stream consisting of 500 vppm NO, 500 vppm NH₃, 5 vol % H₂O, 10 vol % O₂ and balance of N₂, with gas hourly space velocity (GHSV) of 120,000 h⁻¹. Preferably, the metal-promoted zeolite having a CHA-type framework structure according to the present invention exhibits NOx conversions of at least 65% at 200° C. and at least 75% at 575° C., as determined under same conditions as above. More preferably, the metal-promoted zeolite having a CHA-type framework structure according to the present invention exhibits NOx conversions of at least 70% at 200° C. and at least 80% at 575° C., as determined under same conditions as above.

The promoter metal may be incorporated into the zeolite having a CHA-type framework structure via any known processes, for example ion exchange and impregnation. For example, the promoter metal may be incorporated into the zeolite having a CHA-type framework structure by mixing the zeolite into a solution of a soluble precursor of the promoter metal. The zeolite upon ion-exchanging with the promoter metal typically in form of cation may be conventionally washed, dried and calcined. Useful soluble precursors of the promoter metal may be for example salts of the promoter metal, complexes of the promoter metal and a combination thereof. Alternatively, the promoter metal may be incorporated into the zeolite having a CHA-type framework structure in situ during the preparation of catalytic articles such as extrudate or coated monolith as described hereinbelow.

In the fourth aspect, the present invention relates to the use of the zeolite having a CHA-type framework structure obtained and/or obtainable by the process as described in the first aspect in catalysts for selective catalytic reduction (SCR) of nitrogen oxides. Further, the present invention relates to the use of the metal-promoted zeolite having a CHA-type framework as described in the third aspect for selective catalytic reduction (SCR) of NOx.

For the SCR applications, the zeolite having a CHA-type framework structure, preferably the metal-promoted ones as described hereinabove, may be applied in form of an extrudate or in form of a washcoat on a monolithic substrate.

Accordingly, in the fifth aspect, the present invention provides a catalytic article in form of an extrudate comprising an SCR catalyst composition or in form of a monolith comprising a washcoat containing an SCR catalyst composition on a substrate, wherein the SCR catalyst composition comprises the metal-promoted zeolite having a CHA-type framework structure as described in the third aspect.

The term “extrudate” generally refers to shaped body formed by extrusion. According to the present invention, the extrudate comprising the zeolite having a CHA-type framework structure and the promoter metal typically has a honeycomb structure.

The term “washcoat” has its usual meaning in the art, that is a thin, adherent coating of a catalytic or other material applied to a substrate.

The term “substrate” generally refers to a monolithic material onto which a catalytic coating is disposed, for example monolithic honeycomb substrate, particularly flow-through monolithic substrate and wall-flow monolithic substrate.

The zeolite having a CHA-type framework structure and the promoter metal may be processed into the catalytic article by any known processes with no particular restriction.

In a further aspect, the present invention relates to an exhaust gas treatment system comprising an internal combustion engine and an exhaust gas conduit in fluid communication with the internal combustion engine, wherein the catalytic article as described herein is present in the exhaust gas conduit.

In addition thereto, the present invention further relates to a method for selective catalytic reduction of nitrogen oxides, which includes contacting a gas stream comprising nitrogen oxides (NOx) with a metal-promoted zeolite comprising a promoter metal as described in the third aspect, or with the catalytic article as described in the fifth aspect.

The present invention is further illustrated by the following set of embodiments and combinations of embodiments resulting from the dependencies and back-references as indicated. In particular, it is noted that in each instance where a range of embodiments is mentioned, for example in the context of a term such as “The . . . according to any one of embodiments 1 to 4”, every embodiment in this range is meant to be explicitly disclosed for the skilled person, i.e., the wording of this term is to be understood by the skilled person as being synonymous to “The . . . according to any one of embodiments 1, 2, 3, and 4”. Further, it is explicitly noted that the following set of embodiments is not the set of claims determining the extent of protection, but represents a suitably structured part of the description directed to general and preferred aspects of the present invention.

### EMBODIMENTS

1. A process for preparing a zeolite having a CHA-type framework structure comprising X₂O₃ and YO₂, wherein X is a trivalent element and Y is a tetravalent element, which includes
   (1) preparing a synthesis mixture comprising
      (A) a source for X₂O₃,
      (B) a source for YO₂, and
      (C) a source for an organic structure directing agent (OSDA) comprising a diquaternary ammonium cation of formula (I) or a combination of diquaternary ammonium cations of formula (I),

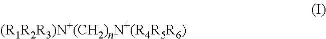

in which
   R₁, R₂, R₃, R₄, R₅ and R₆, independently from each other, are selected from C₁-C₁₀ alkyl, and
   n is an integer in the range of from 3 to 10,
or
in which
   one of R₁, R₂ and R₃ is selected from C₁-C₁₀ alkyl and the other two are linked together to form a C₄-C₆ alkylene,
   one of R₄, R₅ and R₆ is selected from C₁-C₁₀ alkyl and the other two are linked together to form a C₄-C₆ alkylene, and
   n is an integer in the range of from 3 to 10; and
(2) subjecting the synthesis mixture to crystallization conditions to form a zeolite having a CHA-type framework structure.
2. The process according to embodiment 1, wherein in formula (I), R₁, R₂, R₃, R₄, R₅ and R₆, independently from each other, are selected from C₁-C₆ alkyl, and n is an integer in the range of from 3 to 10.
3. The process according to embodiment 2, wherein in formula (I), R₁, R₂, R₃, R₄, R₅ and R₆ are the same and selected from C₁-C₆ alkyl, and n is 4 to 7.
4. The process according to embodiment 3, wherein in formula (I), each of R₁, R₂, R₃, R₄, R₅ and R₆ is methyl, ethyl or propyl, and n is 5, 6 or 7.
5. The process according to embodiment 4, wherein in formula (I), each of R₁, R₂, R₃, R₄, R₅ and R₆ is ethyl.
6. The process according to embodiment 5, wherein in formula (I) each of R₁, R₂, R₃, R₄, R₅ and R₆ is ethyl and n is 5.
7. The process according to any of embodiments 1 to 6, wherein the synthesis mixture has a molar ratio of the diquaternary ammonium cation to the source for YO₂, calculated as YO₂, in the range of from 0.01 to 1.0, for example 0.05 to 0.5, or 0.08 to 0.2.
8. The process according to any of embodiments 1 to 7, wherein X is selected from the group consisting of Al, B, In, Ga and any combinations thereof, and Y is selected from the group consisting of Si, Sn, Ti, Zr, Ge and any combinations thereof.
9. The process according to embodiment 8, wherein X is Al and Y is Si.
10. The process according to any of embodiments 1 to 9, wherein the sources for X₂O₃ and YO₂ comprise FAU zeolites, particularly zeolite Y, more preferably zeolite Y having a molar ratio of XO₂ to Y₂O₃ of no more than 40, preferably of no more than 30.
11. The process according to any of embodiments 1 to 10, wherein the synthesis mixture has a molar ratio of the source for YO₂ calculated as YO₂ to the source for X₂O₃ calculated as X₂O₃ in the range of from 5 to 100, for example 10 to 60, or 15 to 30.
12. The process according to any of embodiments 1 to 11, wherein the synthesis mixture comprises a source for alkali metal and/or alkaline earth metal cations, and has a ratio of the alkali metal and/or alkaline earth metal cations to the source for YO₂, calculate as AM to YO₂, in the range of from 0.01 to 1.0, for example 0.03 to 0.5, or 0.05 to 0.3.
13. The process according to any of embodiments 1 to 12, wherein the synthesis mixture comprises a source for anion OH⁻, and has a molar ratio of the anion OH⁻ to the source for YO₂, calculated as OH⁻ to YO₂, in the range of from 0.1 to 2.0, for example 0.1 to 1.0, or 0.2 to 0.5.
14. The process according to any of embodiments 1 to 13, wherein the organic structure directing agent comprise no cation other than the diquaternary ammonium cation of formula (I).
15. A zeolite having a CHA-type framework structure obtained and/or obtainable by the process according to any of embodiments 1 to 14.
16. The zeolite according to embodiment 15, which has a YO₂:X₂O₃ molar ratio of 2 or more, preferably comprised in the range of from 4 to 200, more preferably of from 6 to 100, more preferably of from 8 to 50, more preferably of from 10 to 35, more preferably of from 15 to 30, most preferably 18 to 25.
17. The zeolite according to embodiment 15 or 16, which has a crystal morphology with a mosaic-pattern texture of crystal surfaces, as observed via SEM.
18. A metal-promoted zeolite having a CHA-type framework structure, which comprises the zeolite according to any of embodiments 15 to 17, and a promoter metal.
19. The metal-promoted zeolite according to embodiment 18, wherein the promoter metal is selected from transition metals, alkali earth metals, Sb, Sn and Bi, and any combinations thereof, preferably comprising Cu and/or Fe, preferably Cu.
20. The metal-promoted zeolite according to embodiment 19, wherein the promoter metal consists of Cu and/or Fe, preferably of Cu.
21. The metal-promoted zeolite according to embodiment 20, wherein the promoter metal is present in the metal-promoted zeolite at an amount in the range of from 0.1 to 1.0 moles, preferably 0.15 to 0.8 moles, more preferably 0.2 to 0.6 moles, most preferably 0.3 to 0.5 moles.
22. The metal-promoted zeolite according to any of embodiments 18 to 21, which, upon steam aging with 10% H₂O at 820° C., exhibits NOx conversions of at least 50% at 200° C. and at least 60% at 575° C. in a test gas stream consisting of 500 vppm NO, 500 vppm NH₃, 5 vol % H₂O, 10 vol % O₂ and balance of N₂, with gas hourly space velocity (GHSV) of 120,000 h⁻¹.
23. The metal-promoted zeolite according to embodiment 22, which, upon steam aging with 10% H₂O at 820° C., exhibits NOx conversions of at least 65% at 200° C. and at least 75% at 575° C., preferably at least 70% at 200° C. and at least 80% at 575° C.
24. A catalytic article in form of an extrudate comprising an SCR catalyst composition or in form of a monolith comprising a washcoat containing an SCR catalyst composition on a substrate, wherein the SCR catalyst composition comprises the metal-promoted zeolite according to any of embodiments 18 to 23.
25. An exhaust gas treatment system, which comprises an internal combustion engine and an exhaust gas conduit in fluid communication with the internal combustion engine, wherein the catalytic article according to embodiment 24 is present in the exhaust gas conduit.
26. Use of the zeolite having a CHA-type framework structure according to any of embodiments 15 to 17 or the metal-promoted zeolite according to any of embodiments 18 to 23 in catalysts for selective catalytic reduction of nitrogen oxides.
27. A method for the selective catalytic reduction of nitrogen oxides, which includes contacting a gas stream comprising nitrogen oxides (NOx) with the metal-promoted zeolite according to any of embodiments 18 to 23 or the catalytic article according to embodiment 24.

The invention will be further illustrated by following Examples, which set forth particularly advantageous embodiments. While the Examples are provided to illustrate the present invention, they are not intended to limit the present invention.

### EXAMPLES

Scanning electron microscopy (SEM) measurements were performed by a scanning electron microscope (Hitachi SU5000).

X-ray powder diffraction (XRD) patterns were measured with PANalytical X'pert³ Powder Diffractometer (40 kV, 40 mA) using CuKα (λ=1.5406 Å) radiation to collect data in Bragg-Brentano geometry.

### Example 1 Preparation of Seeds of CHA Zeolite

814.6 g of an aqueous solution of 1-methyl-1-n-propylpiperidinium hydroxide (12.6 wt %) was mixed with 2814.3 g of DI water, followed by addition of 110.8 g of sodium hydroxide (99%, solid). After sodium hydroxide dissolved, 44.9 g of Zeolite HY (SAR=7.2, from Shandong Duoyou) and 567.6 g of Ludox® AS-40 colloidal silica were added. After stirring at room temperature for 30 mins, the synthesis mixture was transferred into an autoclave with Teflon liner for crystallization. The crystallization was carried out at 150° C. for 5 days under static condition. After cooling to room temperature, the zeolite product was collected by filtration and dried at 120° C. overnight.

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with DI water, dried at 110° C. overnight. The ion-exchange procedure was repeated once and the dried product was calcined at 450° C. for 6 hours to obtain the calcined H-form zeolite.

The zeolite has a SiO₂/Al₂O₃ molar ratio of (SAR) of 14.2 as measured on the calcined H-form by XRF. It was confirmed by the XRD pattern that the zeolite has a typical CHA-type framework.

### Example 2 Preparation of CHA Zeolite with N,N,N,N′,N′,N′-Hexaethyl-1,5-Pentanediammonium Dihydroxide (Et6-Diquat-5 Dihydroxide) (Zeolite A, Calcined H-Form)

260 g of an aqueous solution of Et6-diquat-5 dihydroxide (20 wt %) was mixed with 194.3 g of DI water, followed by addition of 3.2 g of sodium hydroxide (99%, solid). After sodium hydroxide being dissolved, 112.4 g of Zeolite HY (SAR=22, from Qilu Huaxin) was added. After stirring at room temperature for 30 mins, 0.4 g of CHA seed was added and the synthesis mixture was transferred into an autoclave with Teflon liner for crystallization. The crystallization was carried out at 180° C. for 2 days under static condition. After cooling to room temperature, the zeolite product was collected by filtration and dried at 120° C. overnight.

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with DI water, dried at 110° C. overnight. The ion-exchange procedure was repeated once and the dried product was calcined at 450° C. for 6 hours to obtain the calcined H-form zeolite.

The zeolite has a SiO₂/Al₂O₃ molar ratio of (SAR) of 22 as measured on the calcined H-form by XRF.

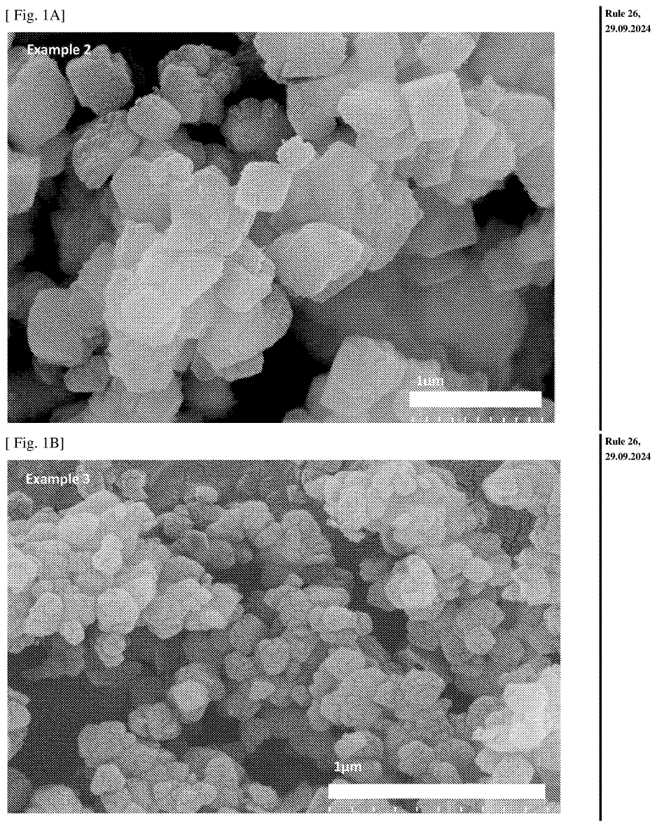

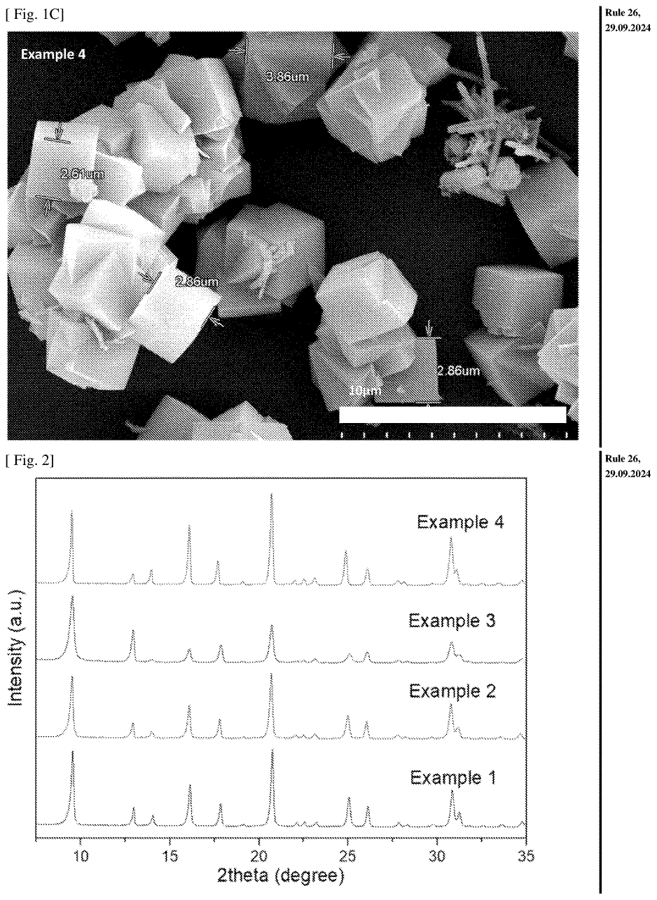

The crystal morphology of the zeolite observed from the SEM image (under 15.0 KV, 6.1 mm×30.0K) and the XRD pattern of the zeolite are shown in FIG. 1A and FIG. 2 respectively. It was confirmed by the XRD pattern that the zeolite has a typical CHA-type framework. Further, a mosaic-pattern texture on surfaces of the zeolite crystals was observed clearly from the SEM picture.

Example 3 Preparation of CHA zeolite with N,N,N,N′,N′,N′-hexaethyl-1,5-pentanediammonium dihydroxide (Et6-diquat-5 dihydroxide) (Zeolite B, calcined H-form) 173.4 g of an aqueous solution of Et6-diquat-5 dihydroxide (20 wt %) was mixed with 208.3 g of DI water, followed by addition of 7.1 g of sodium hydroxide (99%, solid). After sodium hydroxide being dissolved, 35.8 g of Zeolite HY (SAR=7.2, from Shandong Duoyou) and 114.3 g of Ludox® AS-40 colloidal silica were added. After stirring at room temperature for 30 mins, 2.4 g of the CHA seed was added and the synthesis mixture was transferred into an autoclave with Teflon liner for crystallization. The crystallization was carried out at 180° C. for 2 days under static condition. After cooling to room temperature, the zeolite product was collected by filtration and dried at 120° C. overnight.

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with DI water, dried at 110° C. overnight. The ion-exchange procedure was repeated once and the dried product was calcined at 450° C. for 6 hours to obtain the calcined H-form zeolite.

The zeolite has a SiO₂/Al₂O₃ molar ratio of (SAR) of 20, as measured on the calcined H-form by XRF.

The crystal morphology of the zeolite observed from the SEM image (under 15.0 KV, 8.2 mm×50.0K) and the XRD pattern of the zeolite are shown in FIG. 1B and FIG. 2 respectively. It was confirmed by the XRD pattern that the zeolite has a typical CHA-type framework. Further, a mosaic-pattern texture on surfaces of the zeolite crystals was observed clearly from the SEM picture.

### Example 4 Preparation of CHA Zeolite with N,N,N-Trimethyl-1-Adamantyl Ammonium Hydroxide (Zeolite C, Calcined H-Form)

To a solution of 0.5 g of sodium hydroxide (99%, solid) in 35 g of D.I. water, 95 g of sodium silicate, 3 g of sodium sulfate (99%, solid) and then 9 g of Zeolite Na—Y (SAR=5.1, CBV 100 from Zeolyst) were added. Then, 16 g of an aqueous solution of N,N,N-trimethyl-1-adamantyl ammonium hydroxide (TMAdaOH, 20 wt %) was added, and stirred at room temperature for 30 mins. The synthesis mixture was then transferred into an autoclave with Teflon liner for crystallization. The crystallization was carried out at 140° C. for 3 days under static condition. After cooling to room temperature, the zeolite product was collected by filtration and dried at 120° C. overnight.

The as-synthesized zeolite was calcined at 550° C. for 6 hours to remove the organic structure directing agent. The calcined zeolite was crushed and ion-exchanged in a 10 wt % aqueous NH₄Cl solution at a solid/liquid ratio of 1:10. The ion exchange process was carried out at 80° C. for 2 hours, collected by filtration, washed with D.I. water, dried at 110° C. overnight. The ion-exchange procedure was repeated once and the dried product was calcined at 450° C. for 6 hours to obtain the calcined H-form zeolite.

The zeolite has a SiO₂/Al₂O₃ molar ratio of (SAR) of 11, as measured on the calcined H-form by XRF.

The crystal morphology of the zeolite observed from the SEM image (under 15.0 KV, 5.3 mm×5.00K) and the XRD pattern of the zeolite are shown in FIG. 1C and FIG. 2 respectively. It was confirmed by the XRD pattern that the zeolite has a typical CHA-type framework. However, a mosaic-pattern texture on surfaces of the zeolite crystals was not observed from the SEM picture.

### Example 5 Preparation of Cu-Loaded CHA Zeolite Material (SCR Catalyst)

The calcined H-form zeolite powder as obtained was impregnated with an aqueous copper (II) nitrate solution by incipient wetness impregnation and maintained at 50° C. for 20 hours in a sealed container. The obtained solid was dried and calcined in air in a furnace at 450° C. for 5 hours, to obtain Cu-promoted CHA zeolites.

The Cu-promoted CHA zeolites as prepared in accordance with the above general procedure are summarized in the Table 2 below.

TABLE 2

| | | Cu Loading, wt % | Cu/Al |
|---|---|---|---|
| Sample | | on oxide basis, | molar ratio, |
| No. | Zeolite from | as measured by ICP | theoretical |
| A. 1 | Example 2 | 3.5 | 0.32 |
| A. 2 | Example 2 | 3.9 | 0.36 |
| A. 3 | Example 2 | 4.3 | 0.40 |
| A. 4 | Example 2 | 4.7 | 0.44 |
| D. 1 | Example 4 | 7.0 | 0.36 |

### Example 6 Test of Catalyst Performance

For test of SCR performance, each of the Cu-loaded zeolite materials was slurried with an aqueous solution of Zr-acetate and then dried at ambient temperature in air under stirring, and calcined at 550° C. for 1 hour to provide a product containing 5 wt % ZrO₂ as the binder based on the amount of the product. The product was crushed and the powder fraction of 250 to 500 microns was aged at 650° C. for 50 hours or 820° C. for 16 hours in a flow of 10 vol % steam/air to provide the sample for the test.

The selective catalytic reduction (SCR) test was carried out in a fixed-bed reactor with loading of 80 mg of the test sample together with corundum of the same sieve fraction as diluent to about 1 mL bed volume, in accordance with following conditions:
Gas feed: 500 vppm NO, 500 vppm NH₃, 5 vol % H₂O, 10 vol % O₂ and balance of N₂, with gas hourly space velocity (GHSV) of 120,000 hW;
Temperature: RUN1—200, 400, 575° C. (first run for degreening)
   RUN2—175, 200, 225, 250, 500, 550, 575° C.

NOx conversions as measured from RUN 2 at 200° C. and 575° C. are reported as the test results, which are summarized in Table 3 below.

TABLE 3

| | Aged @650° C. | | Aged @820° C. | |
|---|---|---|---|---|
| Sample | NOx conversions, % | | | |
| No. | @ 200° C. | @ 575° C. | @ 200° C. | @ 575° C. |
| A. 1 | 77 | 95 | 74 | 91 |
| A. 2 | 78 | 95 | 77 | 86 |
| A. 3 | 74 | 92 | 77 | 84 |
| A. 4 | 73 | 92 | 79 | 85 |
| D. 1 | 73 | 92 | 0 | 0 |

It can be seen that the catalysts comprising Cu-promoted CHA zeolite according to the present invention are effective for selective catalytic reduction (SCR) of nitrogen oxides.

Surprisingly, upon aging at 650° C., the inventive catalyst A.2 based on the CHA zeolite A as prepared with the diquaternary ammonium cation OSDA (Example 2) exhibits a higher NOx conversion, compared with the comparative catalyst D.1 based on the CHA zeolite D at the same Cu/Al ratio but prepared using conventional TMAdaOH OSDA (Example 4).

Moreover, upon aging at 820° C., the inventive catalysts A.1 to A.4 exhibit greatly improved NOx conversions compared with the comparative catalyst D.1. The inventive catalysts upon aging at 820° C. resulted in NOx conversions at 200° C. of higher than 70% and even up to 79%, and resulted in NOx conversions at 575° C. of higher than 80%, even up to 91%, while the NOx conversion in case of the corresponding comparative catalyst is “0”. The comparatively high SCR activity of the inventive catalysts after aging at 820° C. reflects the high stability of the CHA zeolite at an extremely high temperature.

Although the invention herein has been described with reference to particular embodiments, it is to be understood that these embodiments are merely illustrative of the principles and applications of the present invention. It will be apparent to those of skill in the art that various modifications and variations can be made to the method and apparatus of the present invention without departing from the spirit and scope of the invention. Thus, it is intended that the present invention include modifications and variations that are within the scope of the appended claims and their equivalents.

1. A process for preparing a zeolite having a CHA-type framework structure comprising X₂O₃ and YO₂, wherein X is a trivalent element and Y is a tetravalent element, which includes
(1) preparing a synthesis mixture comprising
(A) a source for X₂O₃,
(B) a source for YO₂, and
(C) a source for an organic structure directing agent (OSDA) comprising a diquaternary ammonium cation of formula (I) or a combination of diquaternary ammonium cations of formula (I), 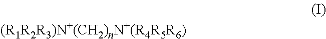
in which
R¹, R₂, R₃, R₄, R₅ and R₆, independently from each other, are selected from C₁-C₁₀ alkyl, and
n is an integer in the range of from 3 to 10,
or
in which
one of R₁, R₂ and R₃ is selected from C₁-C₁₀ alkyl and the other two are linked together to form a C₄-C₆ alkylene,
one of R₄, R₅ and R₆ is selected from C₁-C₁₀ alkyl and the other two are linked together to form a C₄-C₆ alkylene, and
n is an integer in the range of from 3 to 10; and
(2) subjecting the synthesis mixture to crystallization conditions to form a zeolite having a CHA-type framework structure.

2. The process according to claim 1, wherein in formula (I), R₁, R₂, R₃, R₄, R₅ and R₆, independently from each other, are selected from C₁-C₆ alkyl, and n is an integer in the range of from 3 to 10.

3. The process according to claim 2, wherein in formula (I), R₁, R₂, R₃, R₄, R₅ and R₆ are the same and selected from C₁-C₆ alkyl, and n is 4 to 7.

4. The process according to claim 3, wherein in formula (I) each of R₁, R₂, R₃, R₄, R₅ and R₆ is ethyl and n is 5.

5. (canceled)

6. The process according to claim 1, wherein the synthesis mixture has a molar ratio of the diquaternary ammonium cation to the source for YO₂, calculated as YO₂, in the range of from 0.01 to 1.0.

7. The process according to claim 1, wherein X is selected from the group consisting of Al, B, In, Ga and any combinations thereof, and Y is selected from the group consisting of Si, Sn, Ti, Zr, Ge and any combinations thereof.

8. The process according to claim 7, wherein X is Al and Y is Si.

9. The process according to claim 1, wherein the sources for X₂O₃ and YO₂ comprising zeolite Y, wherein zeolite Y has a molar ratio of XO₂ to Y₂O₃ of no more than 40.

10. The process according to claim 1, wherein the synthesis mixture has a molar ratio of the source for YO₂ calculated as YO₂ to the source for X₂O₃ calculated as X₂O₃ in the range of from 5 to 100.

11. The process according to claim 1, wherein the synthesis mixture comprises a source for alkali metal and/or alkaline earth metal cations, and has a ratio of the alkali metal and/or alkaline earth metal cations to the source for YO₂, calculate as AM to YO₂, in the range of from 0.01 to 1.0.

12. The process according to claim 1, wherein the synthesis mixture comprises a source for anion OH⁺ and has a molar ratio of the anion OH⁻ to the source for YO₂, calculated as OH⁻ to YO₂, in the range of from 0.1 to 2.0.

13. The process according to claim 1, wherein the organic structure directing agent comprise no cation other than the diquaternary ammonium cation of formula (I).

14. A zeolite having a CHA-type framework structure obtained and/or obtainable by the process according to claim 1.

15. The zeolite according to claim 14, which has a YO₂:X₂O₃ molar ratio in the range of from 4 to 200.

16. (canceled)

17. A metal-promoted zeolite having a CHA-type framework structure, which comprises the zeolite according to claim 15, and a promoter metal.

18. The metal-promoted zeolite according to claim 17, wherein the promoter metal is selected from transition metals, alkali earth metals, Sb, Sn and Bi, and any combinations thereof.

19. The metal-promoted zeolite according to claim 17, wherein the promoter metal consists of Cu and/or Fe, preferably of Cu.

20. The metal-promoted zeolite according to claim 19, wherein the promoter metal is present in the metal-promoted zeolite at an amount in the range of from 0.1 to 1.0 moles.

21. (canceled)

22. The metal-promoted zeolite according to claim 20, which, upon steam aging with 10% H₂O at 820° C., exhibits NOx conversions of at least 65% at 200° C. and at least 75% at 575° C.

23. A catalytic article in form of an extrudate comprising an SCR catalyst composition or in form of a monolith comprising a washcoat containing an SCR catalyst composition on a substrate, wherein the SCR catalyst composition comprises the metal-promoted zeolite according to claim 17.

24-26. (canceled)
